(19) United States
(12) Patent Application Publication
(10) Pub. No.: US 2013/0073901 A1
(43) Pub. Date: Mar. 21, 2013

(54) DISTRIBUTED STORAGE AND COMMUNICATION

(71) Applicants: Iskender Syrgabekov, Almaty (KZ); Yerkin Zadauly, Almaty (KZ); Chokan Laumulin, London (GB)

(72) Inventors: Iskender Syrgabekov, Almaty (KZ); Yerkin Zadauly, Almaty (KZ); Chokan Laumulin, London (GB)

(73) Assignee: EXTAS GLOBAL LTD., Road Town, Tortola (VG)

(21) Appl. No.: 13/581,744

(22) PCT Filed: Feb. 28, 2011
(86) PCT No.: PCT/GB2011/000275

§ 371 Date: Nov. 30, 2012

(30) Foreign Application Priority Data
Mar. 1, 2010 (GB) 1003407.2

(51) Int. Cl. G06F 12/16; G06F 11/10

(52) U.S. Cl. CPC G06F 12/16; H04L 67/1097; G06F 11/1076
USPC 714/6.24; 709/217; 711/114

(57) ABSTRACT

Apparatus and method of storing, retrieving, transmitting and receiving data comprising a) separating the data into a plurality of data elements, b) matching the position of each data element according to its position in the data with a storage location, c) storing each data element at its matched storage location, d) generating parity data from groups of data elements such that any one or more of the data elements within a group may be recreated from the remaining data elements within the group and the parity data for that group, e) generating further parity data from further groups of data elements formed from the same data elements used in step d) in different combinations and f) storing the parity data and further parity data in separate storage locations.

### FIELD OF THE INVENTION

The present invention relates to a method and system for storing and communicating data and in particular for storing data across separate storage locations, and transmitting and receiving data.

### BACKGROUND OF THE INVENTION

Data may be stored within a computer system using many different techniques. Should an individual computer system such as a desktop or laptop computer be stolen or lost the data stored on it may also be lost with disastrous effects.

Backing up the data on a separate drive may maintain the data but sensitive information may still be lost and made available to third parties. Even where the entire system is not lost or stolen, individual disk drives or other storage devices may fail leading to a loss of data with similar catastrophic effects.

A RAID (redundant array of inexpensive drives) array may be configured to store data under various conditions. RAID arrays use disk mirroring and additional optional parity disks to protect against individual disk failures. However, a RAID array must be configured in advance with a fixed number of disks each having a predetermined capacity. The configuration of RAID arrays cannot be changed dynamically without rebuilding the array and this may result in significant system downtime. For instance, should a RAID array run out of space then additional disks may not be added easily to increase the overall capacity of the array without further downtime. RAID arrays also cannot easily deal with more than two disk failures and separate RAID arrays cannot be combined easily.

Although the disks that make up a RAID array may be located at different parts of a network, configuring multiple disks in this way is difficult and it is not convenient to place the disks at separate locations. Therefore, even though RAID arrays may be resilient to one or two disk failures a catastrophic event such as a fire or flood may result in the destruction of all of the data in a RAID array as disks are usually located near to each other.

Nested level RAID arrays may improve resilience to further failed disks but these systems are complicated, expensive and cannot be expanded without rebuilding the array.

Similarly, portions of transmitted data may also be lost, corrupted or intercepted, especially over noisy or insecure channels.

Furthermore, current data storage and/or transmission methods and devices are prone to corruption and data loss. Even small levels of corruption may affect data quality. This is especially so where the data is used to record high quality audio or visual material as corruption can lead to distortion and loss of quality during playback or from received media.

Therefore, there is required a storage method and system for data that overcomes these problems.

### SUMMARY OF THE INVENTION

According to a first aspect there is provided a method of storing data comprising the steps of:

a) separating the data into a plurality of data elements;

b) matching the position of each data element according to its position in the data with a storage location;

c) storing each data element at its matched storage location;

d) generating parity data from groups of data elements such that any one or more of the data elements within a group may be recreated from the remaining data elements within the group and the parity data for that group;

e) generating further parity data from further groups of data elements formed from the same data elements used in step d) in different combinations; and

f) storing the parity data and further parity data in separate storage locations. Data elements may be portions, subsets or divisions of the data divided or sectioned according to specific requirements. For example, the data elements may be single bits, bytes, groups of bytes, kilobytes or larger, preferably having the same size. The data elements from the data are stored, sequentially or otherwise, by associating each data element with a storage location based on the position of the data element in the data. For example, the data may be a stream of data, an array or an entire file or file system. The position in the data may be a relative position, e.g. every 1st data element is associated with storage location 1, every 2nd data element is associated with storage location 2, etc up to every nth data element. The number n may be predetermined based on the number of available storage locations required to store n data elements and all of the required parity data separately in further storage locations. Therefore, n may be less than the total number of available storage locations.

The mapping of data element position, n, and storage location may be predetermined or calculated when required. This mapping may be stored as a table, lookup table or array, for example. The mapping scheme may be used rather than by cascading or dividing and subdividing the data at each level.

Parity data is generated from groups or sets of data elements and then stored. Further parity data are generated from the same data elements as before but in different combinations. This improves reliability and data recoverability.

Preferably, further parity data is generated from groups of previously generated parity data.

Therefore, the data may be stored by the matching process rather than by cascading data or dividing and subdividing it to fill available storage locations. This technique is more efficient and advantageous where a there is a known number of storage locations required or available.

Preferably, the method may further comprise the steps of:

e) allocating each element of the parity data to a separate storage location; and

f) storing each parity data element in a separate storage location. This improves recoverability and security.

Preferably, the method may further comprise the steps of:

g) allocating each element of the further parity data to a separate storage location; and

h) storing each further parity data element in a separate storage location.

Optionally, the matching may be based on a lookup table of data element position and storage location.

Optionally, the lookup table may be formed by:

i) sequentially dividing the data element positions into two or more sets of positions; and

ii) sequentially allocating each data element position in each set to two or more storage locations. In other words, the lookup table, array or data schema is based on simulates, or is equivalent to a sequential division of the data and parity data.

Optionally, the lookup table is further formed by repeating i) and ii) until no further storage locations are available.

Optionally, the method may further comprise the step of generating a further storage location by dividing an existing storage location. A storage location may be divided any number of times to provide separate or different logical storage areas or locations, as necessary. Should a storage location or logical area fail then further division may be used to place recreated data elements or parity data.

Optionally, each data element may be a bit or set of bits. Alternatively, these may be bytes, groups of bytes or any other subset of the data.

Preferably, each of the storage locations are separate physical devices.

Optionally, the method may further comprising the step of encrypting the data. This improves security.

Advantageously, the separate storage locations may be selected from the group consisting of hard disk drive, optical disk, FLASH RAM, web server, FTP server and network file server.

Optionally, the data may be web pages.

Optionally, the method may further comprise the step of:

applying a function to any one or more of the data elements and parity data to generate one or more associated authentication codes.

Optionally, the function may be a hash function.

Optionally, the hash function may be selected from the group consisting of: checksums, check digits, fingerprints, randomizing functions, error correcting codes, and cryptographic hash functions.

Preferably, the separate storage locations are accessible over a network. This network may be the Internet, for example.

Preferably, the matching and/or storing each data element steps are performed at the same time as the generating parity data and/or generating further parity data steps. In other words, whilst the data elements are being matched with storage locations and then stored according to this match, the parity generation may be taking place in parallel. This further improves efficiency and may speed up the process. When the data are being recovered or received (i.e. if used for transmission and reception) then any data recovery using parity checks, may also be performed in parallel with the building of the original data. This may be especially important where many storage locations are lost or received data is corrupted and many data elements need to be regenerated.

According to a second aspect there is provided an apparatus for storing data comprising a processor arranged to:

a) separate the data into a plurality of data elements;

b) match the position of each data element according to its position in the data with a storage location;

c) storing each data element at its matched storage location;

d) generate parity data from groups of data elements such that any one or more of the data elements within a group may be recreated from the remaining data elements within the group and the parity data for that group;

e) generate further parity data from further groups of data elements formed from the same data elements used in step d) in different combinations; and

f) store the parity data and further parity data in separate storage locations. The apparatus may further incorporate any feature described with respect to the method and be implemented accordingly.

According to a third aspect there is provided a method of transmitting data comprising the steps of:

a) separating the data into a plurality of data elements;

b) matching the position of each data element according to its position in the data with a transmission means;

c) transmitting each data element on its matched transmission means;

d) generating parity data from groups of data elements such that any one or more of the data elements within a group may be recreated from the remaining data elements within the group and the parity data for that group;

e) generating further parity data from further groups of data elements formed from the same data elements used in step d) in different combinations; and

f) transmitting the parity data and further parity data on separate transmission means. The transmission method may further incorporate any feature described with respect to the storage method and be implemented accordingly.

Optionally, each transmission means may be a different type of transmission means or a different transmission channel.

Optionally, the different transmission means may be one or more selected from the group consisting of: wire, radio wave, internet protocol and mobile communication.

Preferably, the different channels are different radio frequencies.

Optionally, the data may be separated into data elements according to the odd or even status of their position in the data.

Optionally, the parity data may be generated by performing a logical function on the plurality of data subsets.

Preferably, the logical function may be an exclusive OR. This is a particularly efficient function but others may be used.

Advantageously, the data may be selected from the group consisting of: audio, mobile telephone, packet data, video, real time duplex data and Internet data.

According to a fourth aspect there is provided an apparatus for transmitting data comprising a processor arranged to:

a) separate the data into a plurality of data elements;

b) match the position of each data element according to its position in the data with a transmission means;

c) transmit each data element on its matched transmission means;

d) generate parity data from groups of data elements such that any one or more of the data elements within a group may be recreated from the remaining data elements within the group and the parity data for that group;

e) generate further parity data from further groups of data elements formed from the same data elements used in step d) in different combinations; and

f) transmit the parity data and further parity data on separate transmission means. The transmission apparatus may further incorporate any feature described above.

According to a fifth aspect there is provided a mobile handset comprising the apparatus described above.

The methods described above may be implemented using computer apparatus or other suitable processors or integrated circuits using software, hardware or firmware, for example. The method may be implemented as instructions within a computer program stored on a computer readable medium or transmitted as a signal, for example.

According to a fifth aspect there is provided a method of retrieving data stored in storage locations comprising the steps of:

a) recovering data elements forming original data and parity data from the storage locations;

b) recreating any missing data elements from the recovered data elements and parity data to form recreated data elements;

c) matching the recovered and any recreated data elements to its position in the original data based on the storage location from which it was recovered or for which it was recreated; and

d) combining the data elements to form the original data according to its matched position.

Preferably, the matching may be based on a lookup table of data element position and storage location.

According to a sixth aspect there is provided an apparatus for retrieving data stored in storage locations comprising a processor arranged or configured to:

a) recover data elements forming original data and parity data from the storage locations;

b) recreate any missing data elements from the recovered data elements and parity data to form recreated data elements;

c) match the recovered and any recreated data elements to its position in the original data based on the storage location from which it was recovered or for which it was recreated; and

d) combine the data elements to form the original data according to its matched position.

According to a seventh aspect there is provided method of receiving data comprising the steps of:

a) receiving data elements forming original data and parity data from separate transmission means;

b) recreating any missing data elements from the received data elements and parity data to form recreated data elements;

c) matching the received and any recreated data elements to its position in the original data based on the transmission means from which it was received or for which it was recreated; and

d) combining the data elements to form the original data according to its matched position.

According to an eighth aspect there is provided an apparatus for receiving data comprising a processor arranged or configured to:

a) receive data elements forming original data and parity data from separate transmission means;

b) recreate any missing data elements from the received data elements and parity data to form recreated data elements;

c) match the received data and any recreated data elements to its position in the original data based on the transmission means from which it was received or for which it was recreated; and

d) combining the data elements to form the original data according to its matched position.

### BRIEF DESCRIPTION OF THE FIGURES

The present invention may be put into practice in a number of ways and embodiments will now be described by way of example only and with reference to the accompanying drawings, in which:

FIG. 1 shows a flowchart of a method for storing data, and used to assist with the description of the present invention, given by way of example only;

FIG. 1a shows a flowchart of an alternative method similar to that shown in FIG. 1;

FIG. 2 shows a schematic diagram of the data stored using the method of FIG. 1;

FIG. 2a shows a schematic diagram of the data stored using the method of FIG. 1a;

FIG. 3 shows a schematic diagram of data stored according to the method of FIG. 1;

FIG. 3a shows a schematic diagram of data stored according to the method of FIG. 1a;

FIG. 3b shows a schematic diagram of data stored according the present invention, given by way of example only;

FIG. 3c shows a flowchart of a method for storing data, according to an aspect of the present invention and given by way of example only;

FIG. 4 shows a schematic diagram of the data distributed as clusters stored following the method of FIG. 1;

FIG. 4a shows a schematic diagram of the data distributed as cluster stored following the method of FIG. 1a;

FIG. 5 shows a flow diagram of a method of storing data, given by way of example only;

FIG. 6 shows a schematic diagram of a network used to store data;

FIG. 7 shows a schematic diagram of a communication system according to a further aspect of the present invention, given by way of example only;

FIG. 7a shows a schematic diagram of a communication system according to a further aspect of the present invention, given by way of example only;

FIG. 8 shows a schematic diagram of a communication system according to a further aspect of the present invention, given by way of example only; and

FIG. 8a shows a schematic diagram of a communication system according to a further aspect of the present invention, given by way of example only.

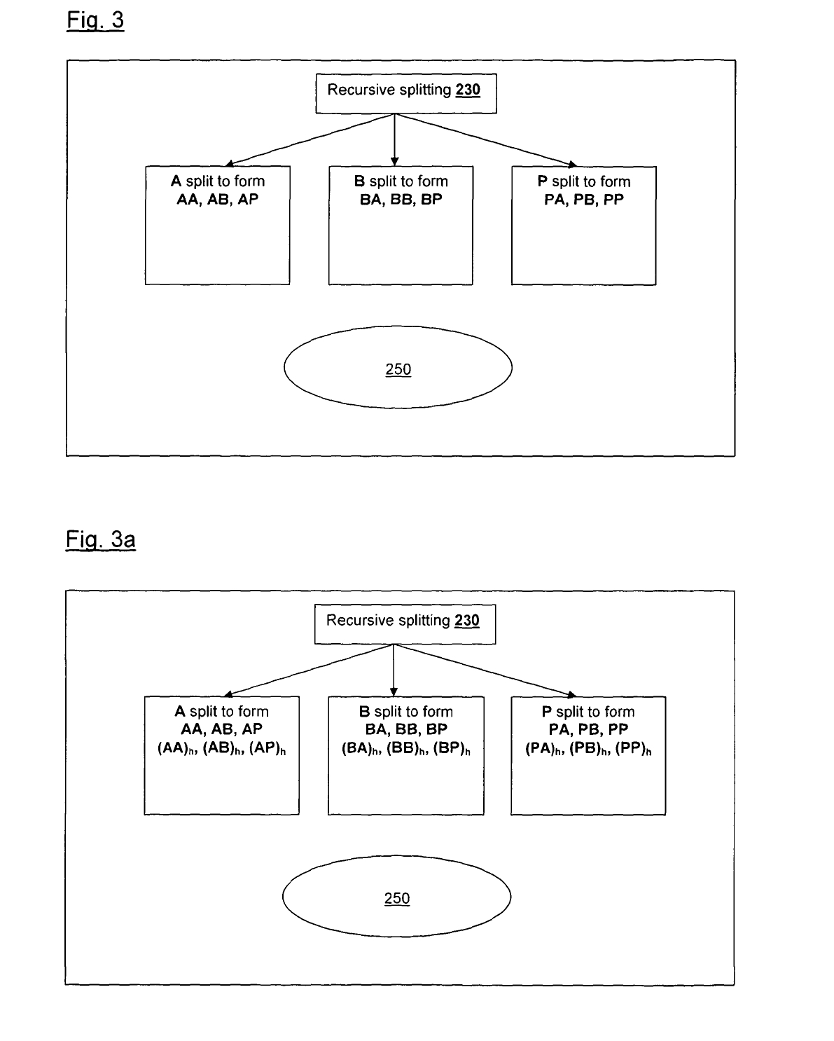

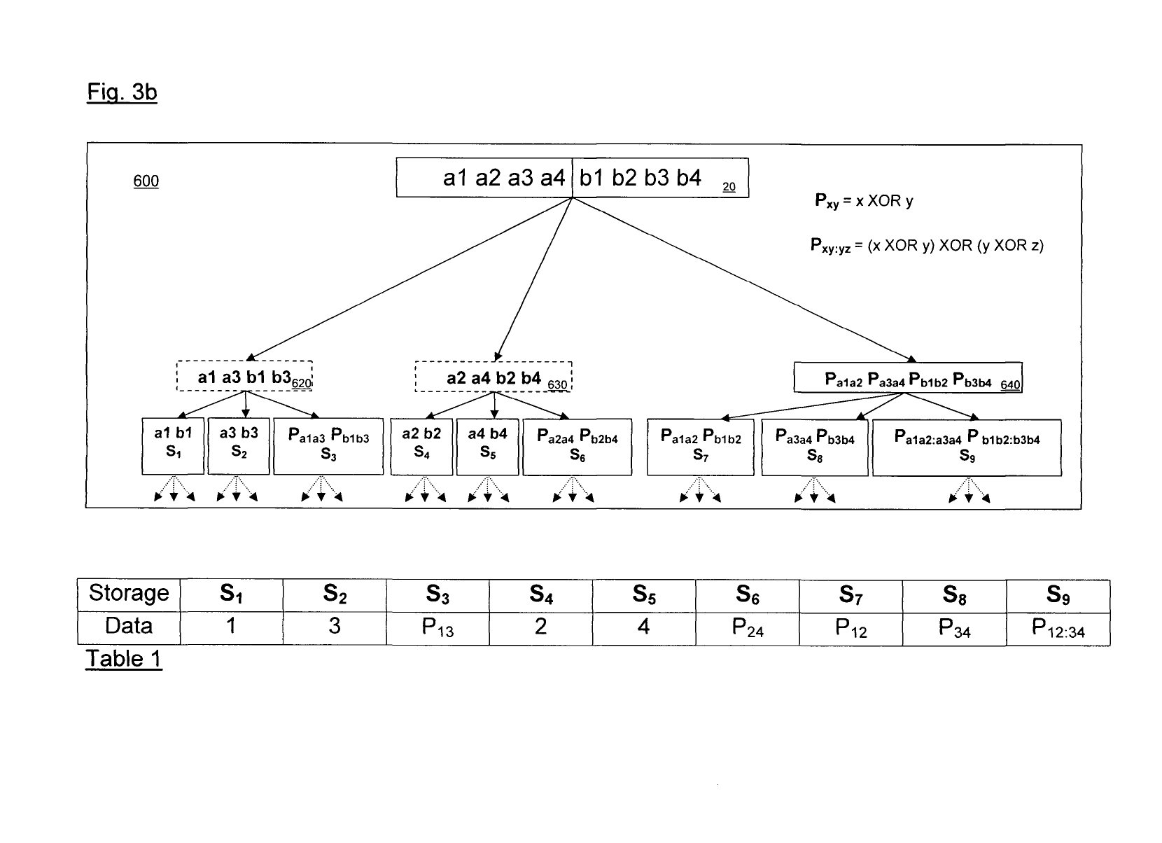

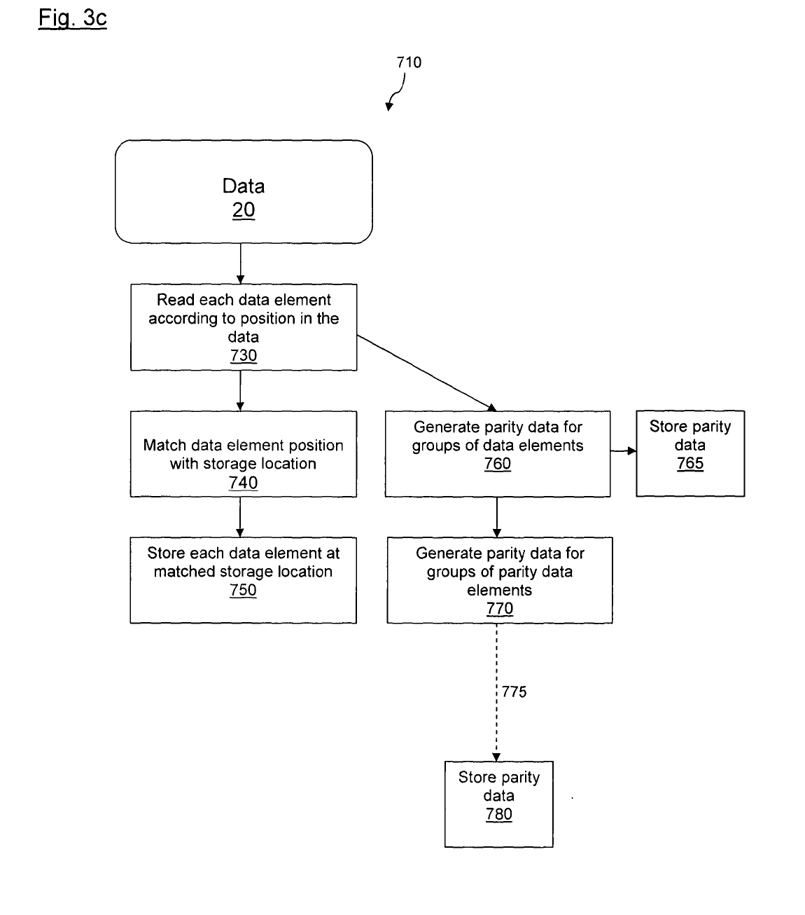

TABLE 1 shows a schematic representation of information used to map the data of FIG. 3b.

It should be noted that the figures and table are illustrated for simplicity and are not necessarily drawn to scale.

### DETAILED DESCRIPTION OF THE PREFERRED EMBODIMENTS

Data to be stored may be in the form of a binary file, for instance. The data may be divided into subsets of data or data elements. Parity data may be generated from the subsets of data in such a way that if one or more of the data subsets is destroyed or lost then any missing subset may be recreated from the remaining subsets and parity data. Parity or control data may be generated from the original data for the purpose of error checking or to enable lost data to be regenerated. However, the parity data does not contain any additional information over that contained in the original data. There are several logical operations that may achieve the generation of such parity data. For instance, applying an exclusive or (XOR) to two binary numbers results in a third binary number, which is the parity number. Should either of the original two binary numbers be lost then it may be recovered by simply performing an XOR between the remaining original number and the parity number. For a more detailed description of a calculation of parity data see http://www.pcguide.com/ref/hdd/perf/raid/concepts/genParity-c.html. Once the parity data has been calculated all of the data subsets and parity data may be stored in separate or remote file locations.

However, each of the data subsets or parity data may be separated into further subsets and further parity data may be generated in order to utilise any additional storage locations. In this way a cascade of data subsets may be created until all available storage locations are utilised or a predetermined limit in the number of locations is reached. The data may be recovered using a reverse process with any missing data subsets being regenerated or recreated from the remaining data subsets and parity data using a suitable regeneration calculation or algorithm. The reading process continues until the original data is recovered.

In one alternative embodiment, authentication or hash codes may be associated with any of the data subsets and/or parity data for use in confirming the authenticity of the data subsets. Authentic data subsets will not have changed or altered deliberately or accidentally following creation of the data subset. This alternative embodiment or its variations are described as authentication embodiments throughout the text.

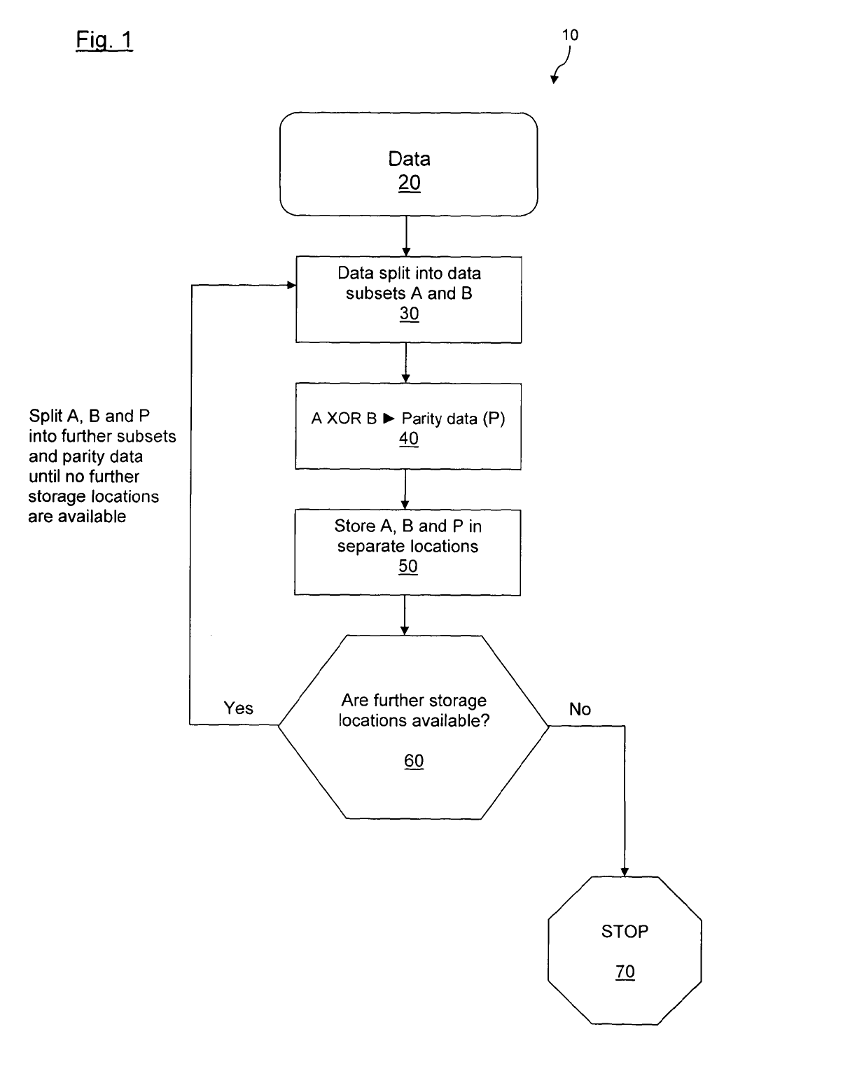

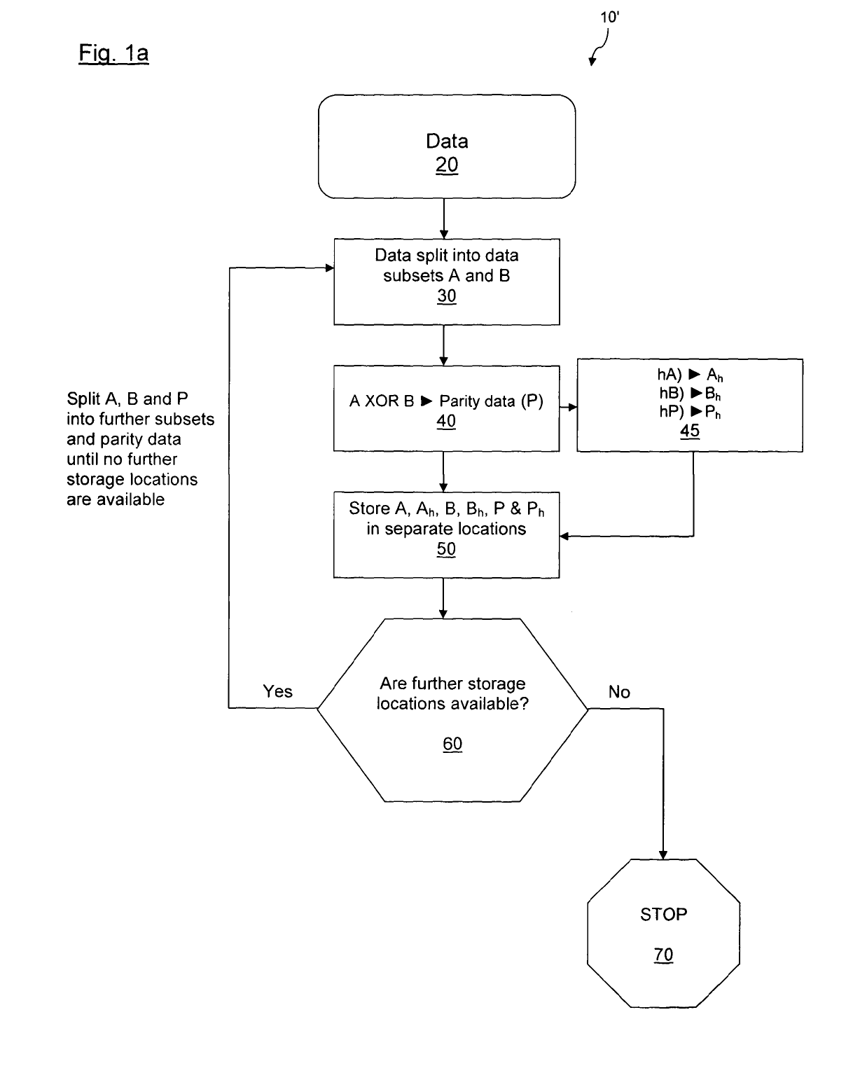

FIG. 1 shows a flow diagram of an example method 10 for storing data. The original data 20 is split into data subsets A and B in step 30. The data may be split into two equal parts, so that the subsets A and B are of equal size. Zero padding may be used to ensure equal sized subsets A and B. For example, additional zero bytes (or groups of bits) may be added to the end of subsets A and B before the parity data P is generated. After the data 20 has been split into subsets A and B an exclusive OR (XOR) operation may be carried out on subsets A and B, at step 40, to generate parity data set P. Alternatively, the parity data P may be generated during the splitting or separation step 30.

In the authentication embodiment method shown as a flow diagram 10′ in FIG. 1a, after the generation of data subsets A and B, a hashing function h(n) may be applied at step 45. This hashing function generates hash codes h(A) and h(B). The parity data P may also be hashed to generate hash code h(P). The hashing function may be chosen such that the computational power to perform it or compare resultant hash codes is acceptable or within system limitations. The hash function may be applied to subsets A, B and/or parity data P. A reduction in computer overhead may be made by not hashing one or more of the data subsets or parity data in any combination.

The resultant two data subsets A and B and parity data set P (and optional hash codes) may be stored at step 50. The subsets A and B and parity data may be stored in memory or a hard drive, for instance. The method 10 may loop at this point. It is determined whether or not there are any further storage locations available or required at step 60. If there are then the method loops back to step 30 where any or each of the data subsets A, B and/or parity data P are further split into new subsets and a further parity data set. The loop continues with each data subset and parity data being divided and generated until there are no further storage locations available or preset and the method stops at step 70.

In the authentication embodiments, the hash or authentication codes may be stored together with the data subsets A and B and/or the parity data P, stored as header information or stored separately, perhaps in a dedicated hash library or store.

Where additional storage locations are available and further looping of the method occurs, the hash generation may be optionally differed until the lowest level of split data is reached, i.e. only the data, which is actually stored rather than any intermediate data subsets. This provides improved efficiency.

In the non-authentication embodiment, the first iteration of the loop of method 10 results in three separate data files (A, B and P); two full iterations results in nine separate data files and three full iterations results in 27 separate data files. Alternatively, it may not be necessary to split each data subset to the same degree. Where there are many storage locations available, the subsets may be split to create further subsets until subsets of a predetermined minimum size are created. Further utilisation of storage locations may then alternatively involve simple duplication in order to improve resilience to data loss.

For the authentication embodiment shown in FIG. 1a, three separate data files are generated (A, B and P) and three hash codes are generated (Aₕ, Bₕ and Pₕ).

With the data 20 being split into nine separate locations four of those datasets may be lost or corrupted (detectable via optional hash code comparison) leaving it still possible to always recreate the original data set 20. More than four may even be lost and still result in accurate regeneration of the original data set 20 but this cannot be guaranteed as it depends on which particular sets are lost.

The hash codes shown in FIG. 1a, may be generated for all stored data files and/or parity data to ensure that corruption or adjustment of the data has not occurred.

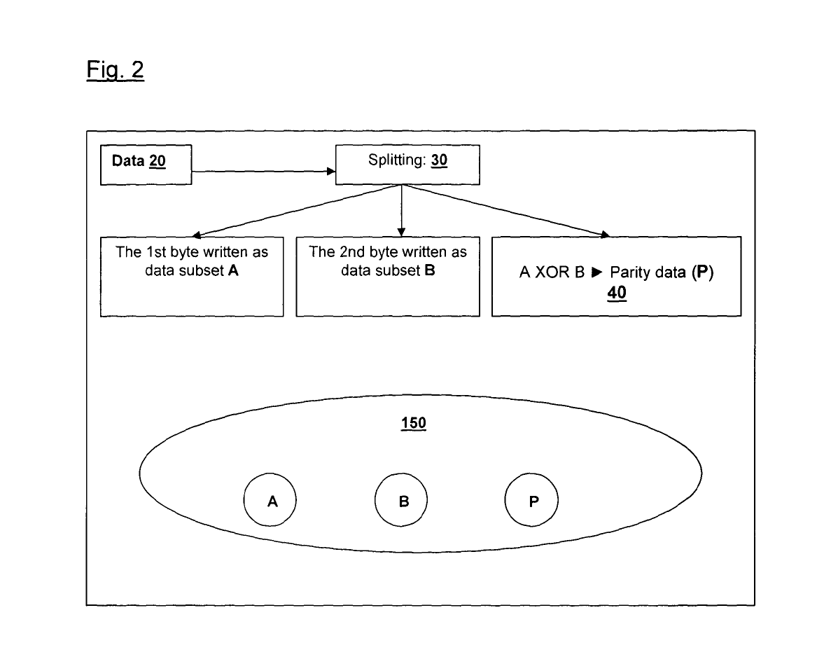

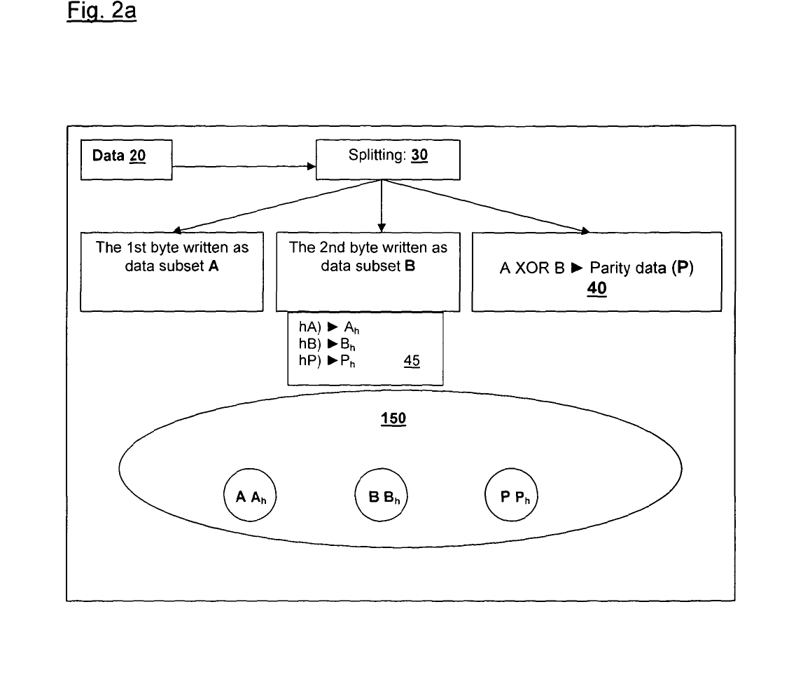

FIG. 2 shows a schematic diagram of the data resulting from a single iteration of the method shown in FIG. 1. Like method steps have the same reference numerals. The original data set 20 is split byte-wise (or bit-wise) to generate data subset A and data subset B (i.e. block size of one byte). The exclusive OR operation generates parity data P. Where there are three separate storage locations available, the method 10 would stop at this stage resulting in a data cluster 150 having three distributed discrete data subsets A, B and P.

FIG. 2a shows an alternative schematic diagram of the data including the hash codes.

FIG. 3 shows the result of a further iteration of steps 30, 40 and 50 of method 10. In this case, nine separate storage locations are available and so each of the three data subsets A, B and P may be further split into three further data subsets each.

As shown in FIG. 3a, in the authentication embodiment, the hash codes are only required for the lowest level of data subsets and/or parity data AA, AB, AP, BA, BB, BP, PA, PB and PP as these are the only files that will be stored for later regeneration, i.e. they require authentication when they are read to ensure authenticity.

The various hash codes may be generated for the lowest level data sets in the cascade.

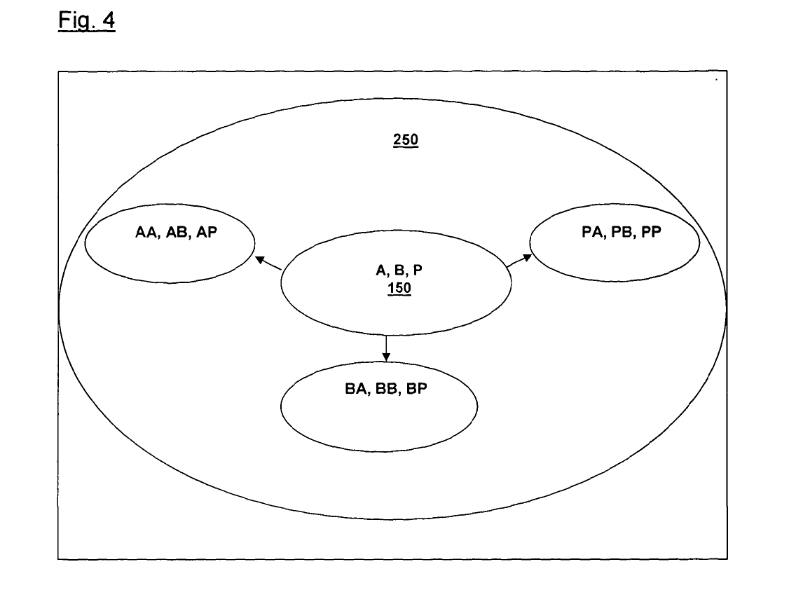

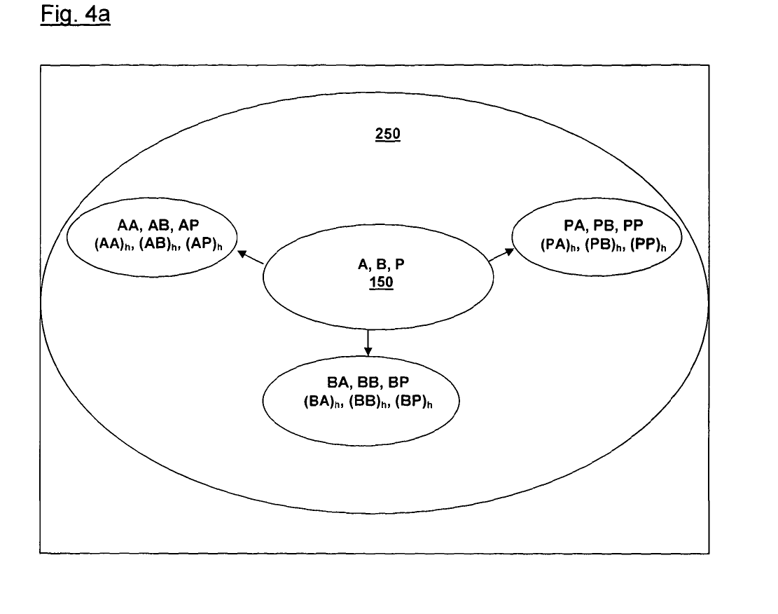

This additional recursive splitting 230 results in data subset A being split to form further data subsets AA and further parity data AP. Similarly, data subset B may be split into BA and BB, which together may be used to form parity data BP. Parity data P may be split into PA, PB and PP. For this particular embodiment of the method each of the three data subsets have the same size. The nine separate data locations used to store each of these nine data subsets may form a second level cluster 250, which is shown in more detail as FIG. 4 (see FIG. 4a for the authentication embodiment).

In other words, the first level cluster 150 has been expanded to form a second level cluster 250. There is therefore no need to store the original three data sets A, B and P (but this may be done anyway as an alternative method for additional resilience to data loss) as these may each be recreated from the nine data subsets in the second level cluster 250. The loop in the method 10 may be repeated as many times as necessary until all available storage locations are used or a predetermined limit is reached of the size of each subset has been reduced to a particular level.

The preceding steps illustrate how to provide data and parity data at particular storage locations so that the data may be recovered should one or more of the individual separate storage locations become unavailable or damaged. This also allows the data to be stored more securely as the location and distribution of the data may be known to only trusted sources. In summary the data may be divided and re-divided in “layers” with parity data calculated at each layer until a cascade of data is formed having a particular number of data subsets and parity data subsets to fill the available storage locations. At the bottom of the cascade the final data subsets and parity are stored at separate storage locations. In other words, the contents of each intermediate step or layer is determined but only the final level may be stored, for example. Portions of intermediate layers may be stored if necessary, to fill up available storage locations.

It is also clear how the data may be recreated following failure of particular storage locations. A “reverse cascade” of data may be achieved knowing where the original data subsets are stored, ultimately resulting in the original data being recreated and reconstructed. However, a more efficient procedure may be used that results in an identical data structure to that described above without necessarily including each of the recursive data splitting steps or layers in between.

This may be achieved by determining in advance for each particular number of separate storage locations, where each data element from the original data 20 will end up in the separate storage locations. Reconstruction of the data may be achieved in the same way as before as the methods are equivalent. A further degree of parallel processing may be employed.

FIG. 3b shows an example to illustrate this more efficient or parallel procedure. In this particular example there are nine separate storage locations S₁-S₉. The data 20 is represented by a stream of data elements a1, a2, a3, etc. A different number of storage locations may be used, e.g. 27 for the next level down having a similar structure.

At the first level of data splitting, data element a1 would be allocated into a first data bin 620 and data element a2 would be allocated to a second data bin 630, according the previous description. FIG. 3b indicates that during the next level of data splitting, data element a1 is stored at storage location S₁ and data element a2 is stored at storage location S₄. Therefore, it is not necessary to calculate the contents of the first 620 and second 630 data bins but these are shown for illustration purposes. Furthermore, data element a3 is stored at storage location S₂ and data element a4 is stored at separate storage location S₅. These particular mappings or matchings of data element position with storage location are shown in Table 1, which may be a lookup table or other type of array stored in memory, for example. A lookup table may be an array-like data structure used to replace a runtime computation with a simpler lookup operation.

Storage locations S₃ and S₆-S₉ each contain parity data in this particular example where nine separate storage locations are used. However, different numbers of separate storage locations may be utilised depending on how the data elements are divided. In the example shown in FIG. 3b, each level in the cascade splits the data in two and provides a single parity data element at each division. Alternatively, each level may split the data three or more times or have different degrees of splitting per layer. This may provide alternative data handling depending on the number of available storage locations. With the data split in two at each level and having two layers requires nine separate storage locations, as shown in FIG. 3b and Table 1. Therefore, the data elements in the original data 20 may be allocated a sequential position (e.g. first, second, third, fourth, first, second, third, forth, etc), with each data element of each position always being stored at the same separate storage location. This is illustrated by the next group of four data elements in the data 20 being b1, b2, b3 and b4, where B1 also ends up in storage location S₁, b2 ends up in storage location S₄, etc.

Therefore, the data splitting at the first level shown as boxes 620 and 630 in dotted lines is not required and the data may be directly stored at the final layer at the separate storage locations by determining the data element position in a series and matching this with the particular storage location defined in advance.

This results in a more efficient procedure as the individual data elements do not need to be allocated to intermediate data bins 620, 630 for each level used.

Furthermore, the parity data associated with the data elements does not need to be calculated until the final layer and so further efficiency is achieved.

Whilst individual data elements may be mapped from the originating data 20 to final storage locations, the parity data may need to be calculated through each level in a cascade with the final level parity data being stored at separate storage locations. It is noted that the parity data stored at storage locations S₇ and S₈ may calculated from different combinations of data elements to those of S₃ and S₆. The parity information stored at location S₉ may be further calculated from the parity information of S₇ and S₈. In other words, it is possible to calculate some (if not all) parity data without the intermediate levels (e.g. that of S₇ and S₈) as it may be determined in advance, which particular data elements from the data, to group together and obtain their parity value. Parity data from the cascaded parity data is again calculated and stored at the final level, e.g. that stored at location S₉. However, the parity calculations may be carried out during the relatively long time required for writing or transmitting the matched data.

FIG. 3c shows a flow chart of the method 710 for writing data to the separate storage locations S₁-S₉ shown in FIG. 3b. Again, in this example, the end result and data stored is identical to that of the method shown in FIG. 1, where the same data 20 is used. However, the pre-mapping may be used to further tune the process with alternative storage structures used. The data 20 may be read sequentially and each data element in the data 20 is associated with its position in the data 20 (step 730). At step 740 each data element is matched according to its position (sequential or otherwise) in the data 20 with a storage location S₁-S₉. At step 750 each data element is stored at its matched storage location. Note that this does not match all of the storage locations, only those used to store data elements.

At a separate branch in the method, which may be carried out in parallel, parity data for groups of data elements that were read at step 730 are generated at step 760 (e.g. stored in this example at locations S₃, S₆, S₇ and S₈). The particular combinations of the groups of data elements used to generate these parity data are known in advance. These parity data may be stored directly in a particular storage location at step 765 as these are equivalent to the final level parity data. The parity data generated at step 760 includes different groupings of data elements. In the present example, each data element is used twice (e.g. for Pₐₗₐ₃ and Pₐₗₐ₂ a1 is used twice with a different data element) but other combinations are possible. In other words, a1 is placed into two parity groups.

The parity data generated entirely form higher level parity data rather than data elements (e.g. those parity data shown in storage locations S₇, S₈ and S₉) are generated at step 770. In the present example, the second level data is stored. However, for implementations where more than two levels of cascade are used (or partially simulated or calculated) then further parity data may be generated to arrive at the final parity data elements which are stored at step 780. These intermediate calculations of parity data are indicated by the dotted line 775.

It is noted that a certain level of parallel processing is further possible with this particular method, whereby calculations may be made whilst data is being stored (which itself have a fairly substantial latency) rather than having to wait for additional calculations before the storage of certain data elements may be achieved, as illustrated in FIG. 1 and its associated description.

Many different combinations and variations are possible and the parity data at the final level may be generated using further, more efficient algorithms where these are more efficient than carrying out the cascade procedure, described above. It is also noted that many different structures of data schema 600 shown in FIG. 3b, may be used depending on the number of required or available separate storage locations and the level of redundancy and recoverability required compared to data storage space available.

The table, look-up table or array shown in Table 1, may be generated for each of these particular data schemas in advance or calculated, as needed. The separate storage locations S₁-S₉ may be described as separate physical devices and may be of different types. Alternatively, separate logical storage locations may be generated by splitting or partitioning or otherwise allocating separate parts of a single storage location on a single device. In the example shown in FIG. 3b, if only eight separate storage locations were available then one of these storage locations may be split into two and defined as two separate logical storage locations. This may be preferable to moving up a level in a cascade and only having three separate storage locations.

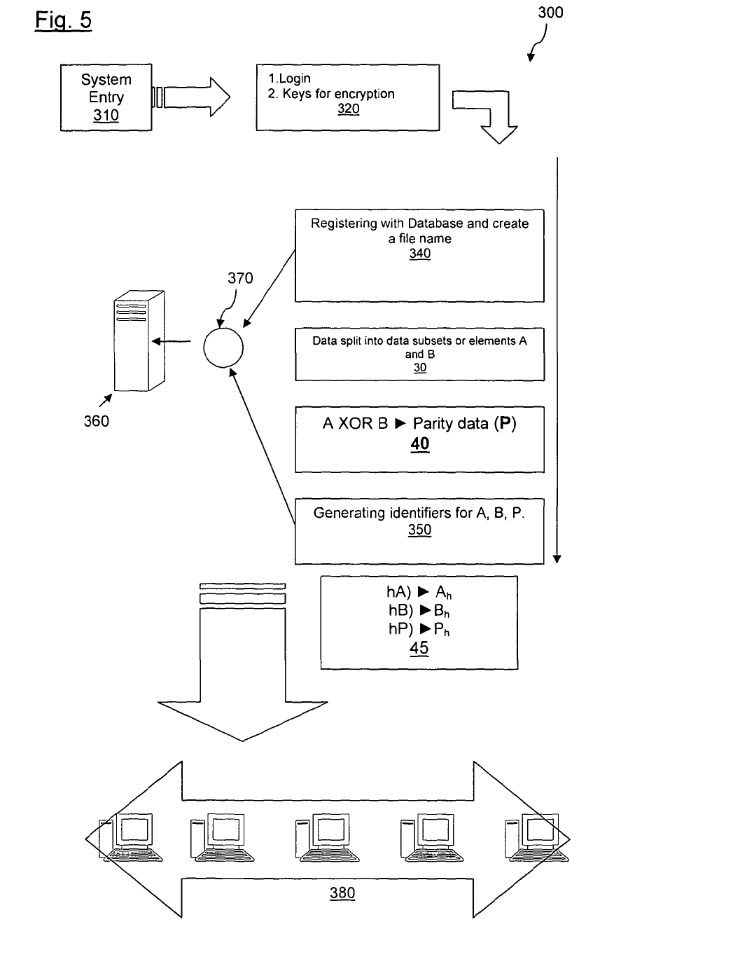

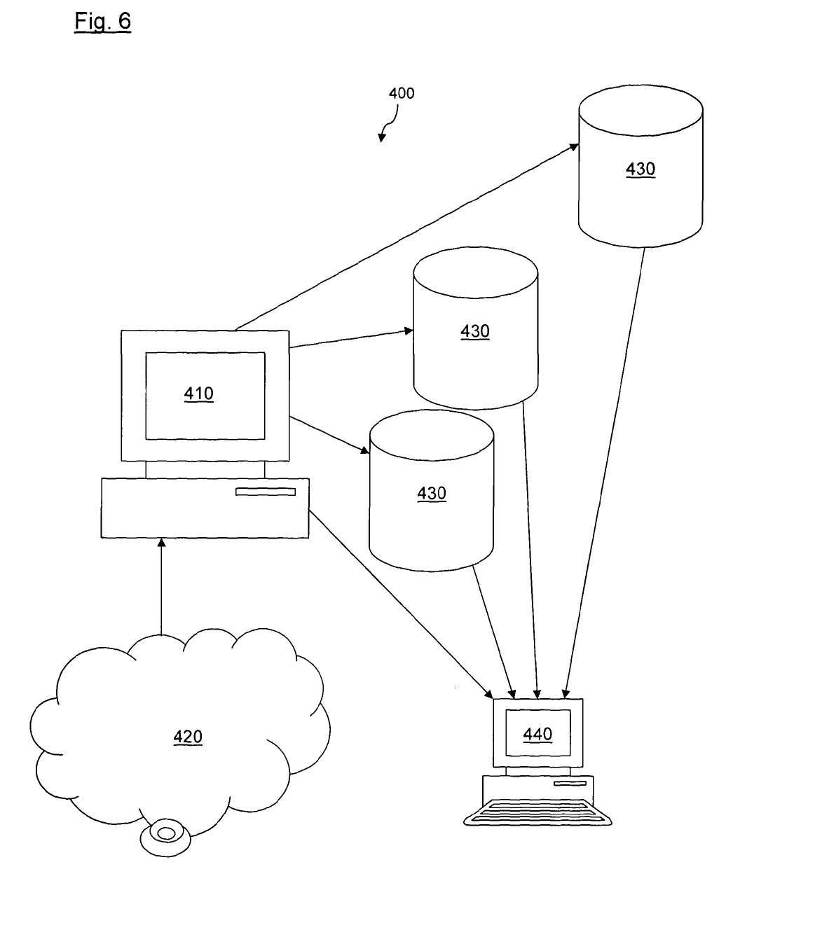

FIG. 5 shows a schematic diagram of a system 300 used to store data according to the method 10 shown in FIG. 1. The system shown in FIG. 5 shows additional optional steps used to enhance the security and reliability of the system 300 according to the authentication embodiment. A central server 360 administers the method and receives a request from a user to enter the system 310. The user logs on and is provided with encryption keys 320. Furthermore, a set of hash-codes (which may be unique) may be generated at step 45, which serves as a unique identifier for the file, which may be used to guarantee authenticity. Encryption keys may be used to generate the hash codes. In this particular embodiment a file is being stored as data 20. A database 370 is used to store log-in information and encryption keys and also the name of files to be stored. The user registers with the database to create a file name at step 340 and the data file is split into subsets A and B and parity data P is created from these data subsets. Each of the data subsets and parity data are assigned an identifier at step 350, which is also administered by the database 370. Separate storage locations are accessible over a network and form a pool of available storage locations 380. The server 360 may determine the maximum level of recursive splitting (or equivalent) to be achieved, which may be determined by predefined preferences or system parameters. The server 360 also monitors the availability of each individual separate storage location within the pool 380.

In this way, individual users may back-up particular files or their entire data storage system over any particular number of separate storage locations from an available pool 380. The server 360 may administer the storage as a processing layer invisible to the user. In other words, once they have accessed the system the storage of data appears to the user as conventional storage and retrieval. The original data 20 may be retrieved from the pool of storage locations 380 whilst any missing data may be regenerated using the parity data P. from any required data layer. The server 360 keeps track of the level of data cascading (or equivalent) and each data subset. The server may also store and administer the hash codes, which may be stored separately or together with the data subsets and parity data.

Furthermore, the data subsets may be encrypted using the encryption keys and a tamper or distortion prevention facility may be incorporated using the hash-code. Therefore, the system 300 shown in FIG. 5 provides additional safety to the user storing sensitive information, as a third party having access to any or all of the individual separate storage locations within this storage pool 380 cannot recreate the original data 20 without the original encryption keys administered by the server 360. Alternatively, no encryption key may be required but there may be a prohibitive level of computing power needed to generate an altered data subset with the same hash code as the original. The encryption keys may also be used to encrypt the data subsets for added security. Intercepting the transfer of data subsets between the storage pool 380 and the user by a third party also does not result in any data becoming available to them without the encryption keys, or obtaining copies of at least a minimum number of data subsets.

A further embodiment of a system used to perform the method 10 or 710 is shown in FIG. 6. The system 400 shown in FIG. 6 may be used to distribute information securely over networks such as the Internet or an intranet. The Internet or subsets of web pages 420 may be distributed securely to a user machine 440 via a central server 410. The central server 410 takes the web pages 420 and stores them according to the method 10 shown in FIG. 1 within separate storage locations 430. The data subsets may be encrypted and/or hashed to provide authentication, as described with reference to FIG. 5. Central server 410 supplies the user machine 440 with a decryption code or codes and information to identify and locate data subsets from particular storage locations 430 and how to recreate the data forming the original web pages 420. Therefore, the web pages 420 are no longer prone to a single point of failure or attack (for instance, a single web server going down) as the original data 20 is distributed amongst separate storage locations 430. Furthermore, any third party intercepting the network traffic of the user computer 440 would not be able to decrypt or recreate the original data forming the web pages 420 without the decryption keys and regeneration information supplied by the central server 410.

Alteration may be detected by rehashing the data subsets and/or parity data and comparing the resultant hash code with that associated with the original. Where a difference is detected this data subset or parity data may be rejected and recreated using only authenticated data sets and/or parity data. Only data subsets or elements that fail authentication by the hash codes (or are otherwise lost or unavailable) need to be recreated or regenerated.

Such a secure system may be suitable for banking transactions or other forms of secure data or where the system user requires additional privacy and security.

The central server 410 may be able to store or cache the entire available Internet or any particular individual websites and make these available only to particular subscribing users. The central server 410 may also perform the function of a search engine or other central consolidator of information. Querying the search engine in this way may render search results containing decryption keys and information used to locate and regenerate the websites or other retrievable documents.

A further use for such a storage system according to the authentication embodiment, is to store and recreate high quality media avoiding distortion and missing data. For instance, higher quality audio or video recordings may be obtained due to the high level of error checking used. Each data subset may be checked for authenticity (e.g. corruption) using the authentication or hash codes. Any data subset that fails this authentication test may be rejected and regenerated using the parity data and any data subsets that pass authentication (the parity data may also be checked).

For instance this storage method may be implemented on hard drives, optical discs such as CDs, DVDs and Blueray™ and file encoding similar to MP3 and MPEG type encoding. The method may be used to generate higher quality multimedia files.

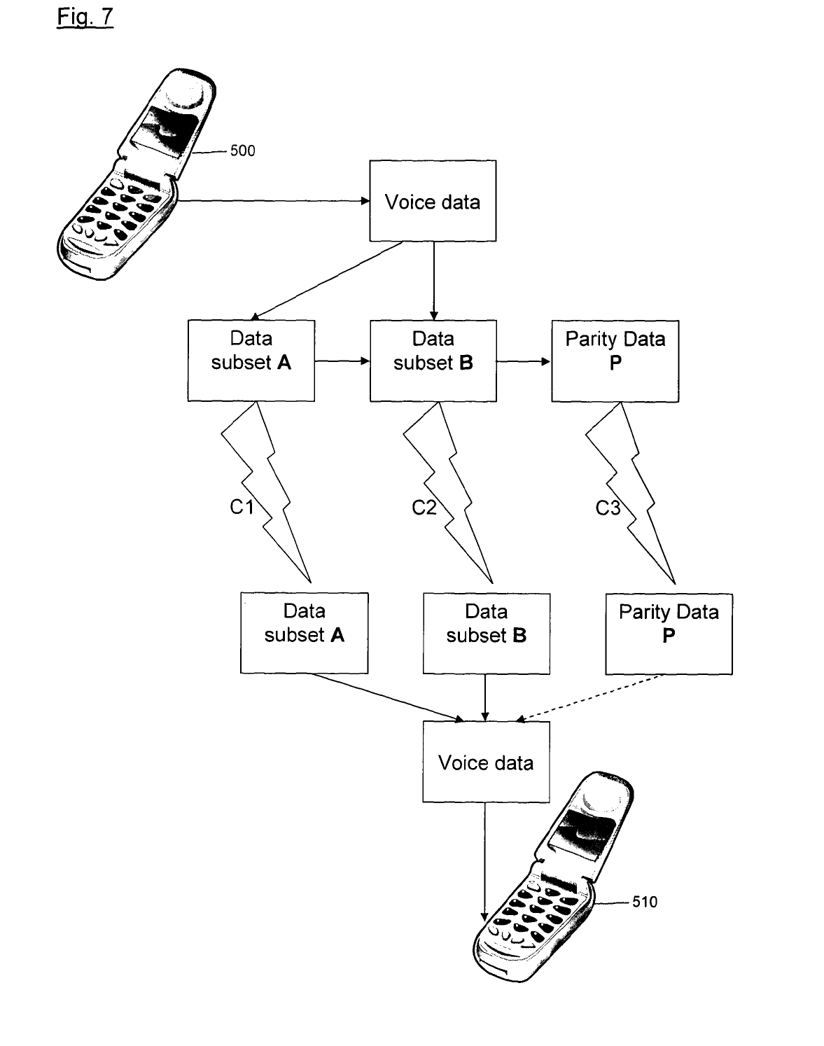

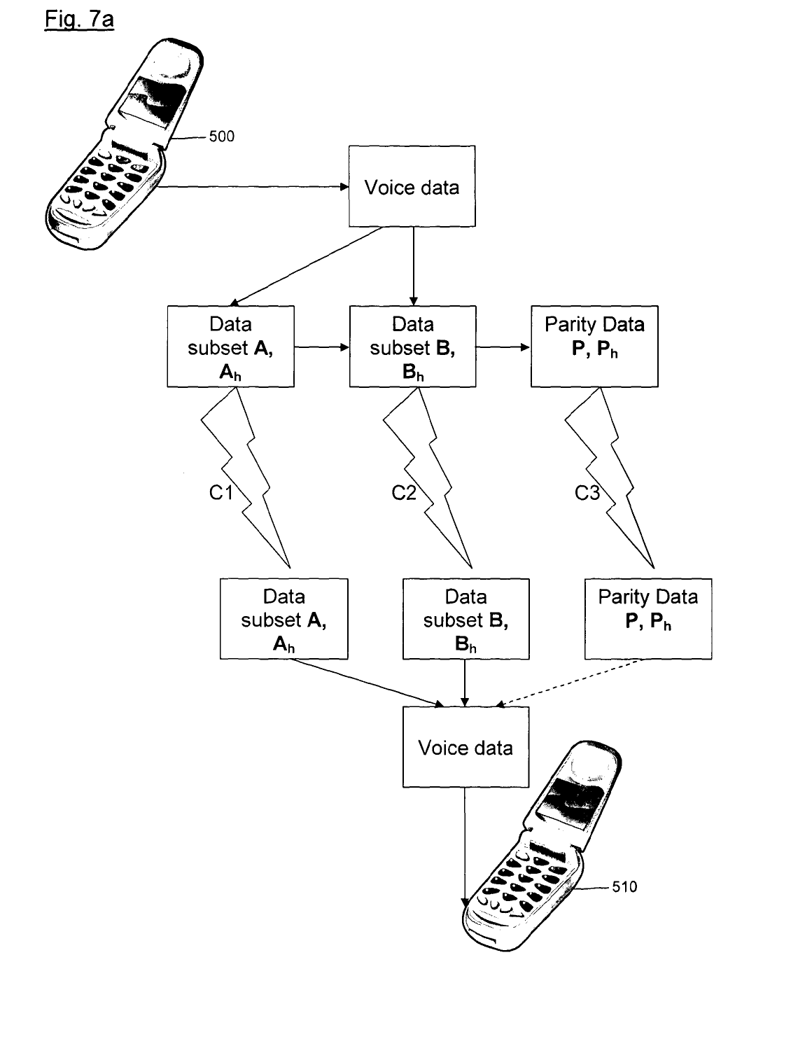

FIG. 7 shows a schematic diagram of a communication system. Two communication devices 500, 510 transmit and received data to and from each other. This may be via a communication network such as a cellular network or directly as in two-way radios. In the following example voice data is used as an illustration. However, many other types of data may also be transmitted and received such as for instance, video, web or Internet and data files.

As shown in FIG. 7, voice data is split into data subsets or elements and parity data using a similar method to that described with respect to FIGS. 1 and 3c for data storage. These data subsets or elements A, B and parity data P are transmitted separately across individual channels C1, C2 and C3 or other transmission means. These data sets may be transmitted according to other schemes together or separately and may be transmitted using different mediums, for instance a mixture of wireless, cable and fibre optic transmission. The splitting function may be carried out within the communication device 500 or within a transmission network facility such as a mobile base station or similar. A cellular telephone may be adapted by the additional of additional hardware to implement the described functions. Alternatively, the functions may be implemented as software.

As with the data storage embodiments, as an alternative authentication embodiment, hash codes may be generated from hash or other authentication functions and associated with the data subsets prior to transmission. This authentication embodiment is illustrated in FIG. 7a.

Data subsets A and B may be combined to form the original voice data as a reverse of the splitting procedure. If either subsets or elements A or B are lost, missing from the received transmission or fail a hashing match test then parity data P may be used to regenerate the missing data in a similar way to the retrieval of stored data described above. An eavesdropper receiving only one of channels C1, C2 or C3 will therefore not be able to reconstruct the voice data. Therefore, this provides a more secure as well as more reliable communication system and method. Security may be enhanced further by differing the mode, type or frequency of each channel. Integrity may be provided by the hash function authentication checks in the authentication embodiment shown in FIG. 7a.

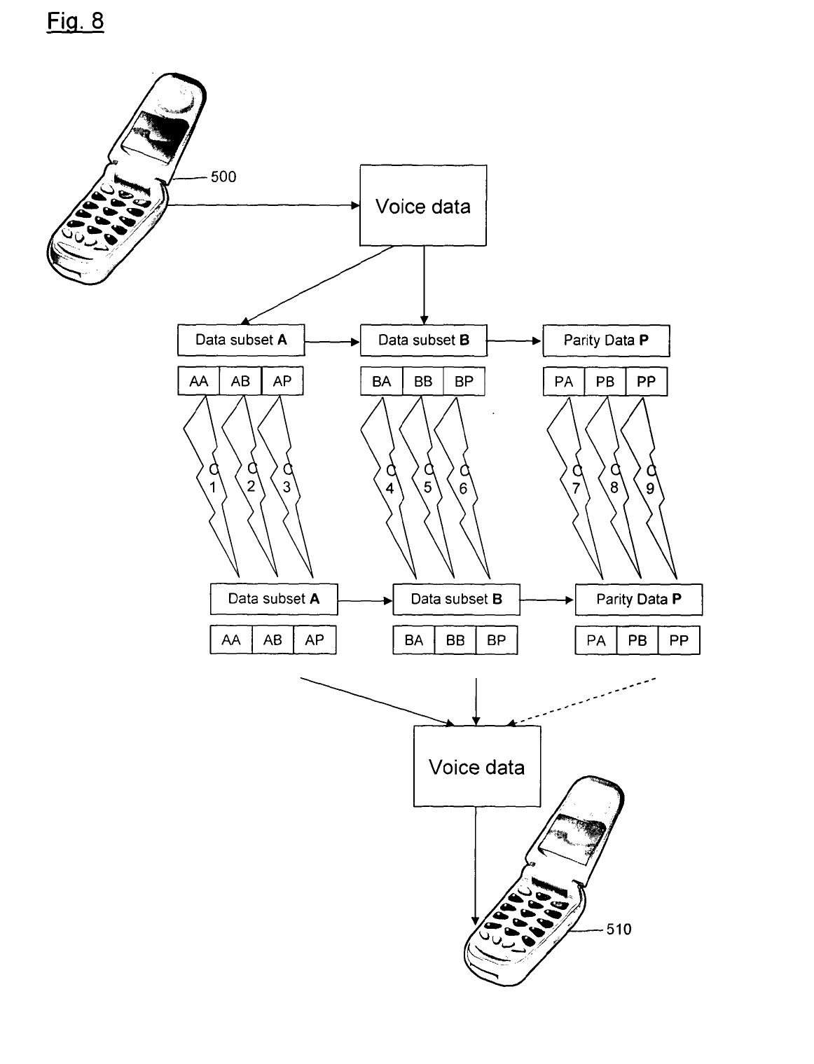

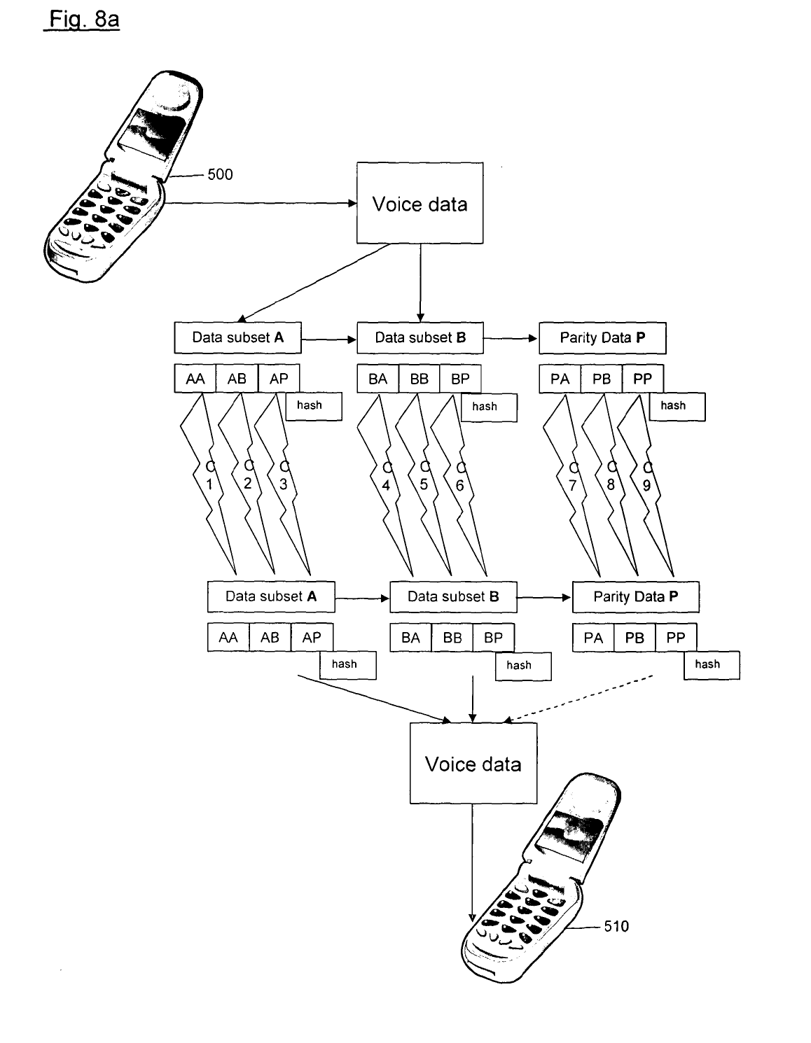

FIG. 8 shows a schematic diagram of a further embodiment similar to that shown in FIG. 7. However, this further embodiment implements a further cascade or layer (or equivalent) of data splitting before transmission. A further level of recombination may be used to reconstruct the voice or other transmitted data. The data may also be matched directly to its original data position using a lookup table or similar mapping technique. In the example shown in FIG. 8 this further cascade of data splitting and parity data generation requires nine channels to communicate each data subset and parity data. Such an additional cascade provides further resilience to data loss. The data transmitted from five of the channels may be lost with the data fully reconstructable (lossless). Further cascade may be achieved providing further resilience. Just as with the data storage example above, other numbers of channels of data may be used. For instance the data may be split three, four or five ways or more at each cascade. Further cascade levels may be implemented dependent on the required level of security or reliability. This further fills the available channel capacity but in so doing so reduces the power requirements of each channel to maintain the same probability of data loss (Shannon or noisy-channel coding theorem).

As shown in FIG. 8a, the transmitted data subsets and/or parity data (lowest levels in the cascade) may any or each have the hash function applied to them. The hash codes may be transmitted to the receiver.

The communication system may also comprise an additional layer of security or functionality. The communication device 510 receiving the data may require information as to which data subsets and parity data are transmitted over which particular channels. In the example shown in FIGS. 8 and 8a, channel C1 is used to transmit data subset AA, C2 is used for AB, etc, however, any combination may be used. Such information may be exchanged between communication devices 500, 510 before or during transmission, by for instance transmission of a code denoting a particular combination of channels and data subsets. The particular combination may vary during transmission and reception. This may be according to a prearranged or predetermined scheme or the particular current combination may be transmitted to keep the transmitter and receiver synchronised. Both communication devices 500, 510 may both transmit and receive simultaneously or in isolation.

As a further security precaution, the data may be stored or transmitted as difference or delta data relative to a reference file. Therefore, access to or knowledge of the reference file may be required in order to retrieve or receive the data.

This further security precaution may be used where there are practical or legal restrictions on transmitting or storing certain types or data. For instance, the storage of banking or confidential information may be restricted to a particular organisation or site. However, it may still be necessary to store these data such that the risk of their loss is reduced. Therefore, it may not be possible to distribute or transmit these types of data across different storage locations, as described previously, even using encryption. This problem may be addressed by instead transmitting and distributing the difference or delta data instead of the underlying data. In this situation, data protection requirements are met and the data may be secured against loss or corruption.

For example and as an illustration of this further alternative procedure, file A (or signal A) may be the underlying data required to be stored or transmitted. File B may be the reference file. A comparison of file A and file B may be made using a comparison function similar to UNIX diff, rdiff or rsync procedures to generate file C.

In a further alternative, the difference file may be generated by applying the XOR function to file A and file B, perhaps byte-wise or bit-wise, for example.

File C is therefore a representation or encoding of the difference between file A and file B; file A cannot be regenerated from file C without knowledge or access to file B. File B may take many different forms and may be a randomly generated string, a document, an audio file, a video file, the text of a book or any other known or generated data set, for example. The benefit of using a known data file (e.g. an MP3 file of a well known song) is that if the user's computer is lost, stolen or corrupted then the underlying data may be regenerated by acquiring a further copy of the known and publicly available reference file. The user must simply remember which particular file they used (perhaps a MP3 file of the user's favourite song). As there are millions of options to a user, security can remain relatively high even when a well-known data file is used.

In order to regenerate file A from file C, a function may be used to apply the difference or delta file C to the reference file B. Various methods may be used in for regenerating file A depending on how the difference or delta file C was generated and encoded. In the XOR example, a further XOR function may be applied to files C and B to regenerate file A. This may be done on a byte-by-byte or bit-by-bit basis, for example. It is likely that that files A and B will be of different sizes. Where file A is smaller than file B then the procedure may simply stop when each byte or file chunk has been compared. Where file A is larger than file B then multiple copies of file B may be used until each byte of file A has been compared. Other variations, difference procedures and comparison functions may be used.

Once the difference or delta file (or data stream) has been generated then this may be used as the original data described above and stored or transmitted (e.g. as voice data), accordingly. For the transmission and receiving embodiments, the difference data may be generated as a data stream, i.e. transmitted, received and encoded or decoded in real time. In other words, the difference data may be divided into data subsets with parity data generated so that these data subsets may be stored in a distributed way or transmitted according to the methods described above.

Where a data stream, in the form of difference data, is to be transmitted then the reference file (B) may again be used to sequentially encode the data stream in real-time. Should the data stream exceed the length of the reference file then the reference file may be reused until transmission ends. In voice communication, for example, each time transmission starts, the beginning of the reference file may be used for comparison with a digitised voice or audio data stream to generate the difference data stream. Alternatively, reuse may be reduced by continuing from the last point used in the reference file for each new transmission. This alternative may further improve security.

It should be noted that although separate embodiments have been described, features of these embodiments may be interchanged, especially regarding data manipulations. Furthermore, features described with respect to the transmission and reception embodiments may be used with the storage embodiments and visa versa.

As will be appreciated by the skilled person, details of the above embodiment may be varied without departing from the scope of the present invention, as defined by the appended claims.

For example, the data may be stored on many different types of storage medium such as hard disks, FLASH RAM, web servers, FTP servers and network file servers or a mixture of these. Although the files are described above as being split into two data subsets (A and B) and a single parity data block (P) during each iteration three (A, B and C), four (A-D) or more data subsets may be generated.

The parity data is described in the example as being generated from the XOR function but other functions may be used. For instance, Hamming, Reed-Solomon, Golay, Reed-Muller or other suitable error correcting codes may be used.

The data subsets maybe stored in physically separate or logically separate locations even within the same hard disk drive or cluster.

The communications systems described with reference to FIGS. 7, 7a, 8 and 8a may also use the matching scheme descried with reference to FIGS. 3b and 3c. In other words, the map data elements of the voice or other transmitted data may be mapped or matched to transmission means or channels based on position in the data stream.

The matching implementation (an embodiment of which is described with reference to FIGS. 3b and 3c) may also use the authentication, hashing and encrypting features described above. Furthermore, any of the features described specifically relating to one embodiment or example may be used in any other embodiment by making the appropriate changes.

Each storage location may be allocated to multiple data element positions, e.g. storage location S₁ may store all of the first and third data elements.

Many combinations, modifications, or alterations to the features of the above embodiments will be readily apparent to the skilled person and are intended to form part of the invention.

1. A method of storing data comprising the steps of:
a) separating the data into a plurality of data elements;
b) matching the position of each data element according to its position in the data with a storage location;
c) storing each data element at its matched storage location;
d) generating parity data from groups of data elements such that any one or more of the data elements within a group may be recreated from the remaining data elements within the group and the parity data for that group;
e) generating further parity data from further groups of data elements formed from the same data elements used in step d) in different combinations; and
f) storing the parity data and further parity data in separate storage locations.

2. The method according to claim 1 further comprising the steps of:
e) allocating each element of the parity data to a separate storage location; and
f) storing each parity data element in a separate storage location.

3. The method according to claim 1 further comprising the steps of:
e) allocating each element of the further parity data to a separate storage location; and
f) storing each further parity data element in a separate storage location.

4. The method according to claim 1, wherein the matching is based on a lookup table of data element position and storage location.

5. The method of claim 4, wherein the lookup table is formed by:
i) sequentially dividing the data element positions into two or more sets of positions, and
ii) sequentially allocating each data element position in each set to two or more storage locations.

6. The method of claim 5, wherein the lookup table is further formed by repeating i) and ii) until no further storage locations are available.

7. The method according to claim 1 further comprising the step of generating a further storage location by dividing an existing storage location.

8. The method according to claim 1, wherein each data element is a bit or set of bits.

9. The method according to claim 1, wherein each of the storage locations are separate physical devices.

10. The method according to claim 1, further comprising the step of encrypting the data.

11. The method according to claim 3, wherein the separate storage locations are selected from the group consisting of hard disk drive, optical disk, FLASH RAM, web server, FTP server and network file server.

12. The method according to claim 1, wherein the data are web pages.

13. The method according to claim 1, further comprising the step of:
applying a function to any one or more of the data elements and parity data to generate one or more associated authentication codes.

14. The method of claim 13, wherein the function is a hash function.

15. The method of claim 14, wherein the hash function is selected from the group consisting of: checksums, check digits, fingerprints, randomizing functions, error correcting codes, and cryptographic hash functions.

16. The method according to claim 3, wherein the separate storage locations are accessible over a network.

17. The method according to claim 1, wherein the matching and/or storing each data element steps are performed at the same time as the generating parity data and/or generating further parity data steps.

18. A method of retrieving data stored in storage locations comprising the steps of:
a) recovering data elements forming original data and parity data from the storage locations;
b) recreating any missing data elements from the recovered data elements and parity data to form recreated data elements;
c) matching the recovered and any recreated data elements to its position in the original data based on the storage location from which it was recovered or for which it was recreated; and
d) combining the data elements to form the original data according to its matched position.

19. The method according to claim 18, wherein the matching is based on a lookup table of data element position and storage location.

20. Apparatus for storing data comprising a processor arranged to:
a) separate the data into a plurality of data elements;
b) match the position of each data element according to its position in the data with a storage location;
c) storing each data element at its matched storage location;
d) generate parity data from groups of data elements such that any one or more of the data elements within a group may be recreated from the remaining data elements within the group and the parity data for that group;
e) generate further parity data from further groups of data elements formed from the same data elements used in step d) in different combinations; and
f) store the parity data and further parity data in separate storage locations.

21. Apparatus for retrieving data stored in storage locations comprising a processor arranged to:
a) recover data elements forming original data and parity data from the storage locations;
b) recreate any missing data elements from the recovered data elements and parity data to form recreated data elements;
c) match the recovered and any recreated data elements to its position in the original data based on the storage location from which it was recovered or for which it was recreated; and
d) combine the data elements to form the original data according to its matched position.

22. A method of transmitting data comprising the steps of:
a) separating the data into a plurality of data elements;
b) matching the position of each data element according to its position in the data with a transmission means;
c) transmitting each data element on its matched transmission means;
d) generating parity data from groups of data elements such that any one or more of the data elements within a group may be recreated from the remaining data elements within the group and the parity data for that group;
e) generating further parity data from further groups of data elements formed from the same data elements used in step d) in different combinations; and
f) transmitting the parity data and further parity data on separate transmission means.

23. The method of claim 22, wherein each transmission means is a different type of transmission means or a different transmission channel.

24. The method of claim 23, wherein the different transmission means are one or more selected from the group consisting of: wire, radio wave, internet protocol and mobile communication.

25. The method of claim 23, wherein the different channels are different radio frequencies.

26. The method according to claim 1, wherein the data are separated into data elements according to the odd or even status of their position in the data.

27. The method according to claim 1, wherein the parity data are generated by performing a logical function on the plurality of data subsets.

28. The method of claim 27, wherein the logical function is an exclusive OR.

29. A method according to claim 22, wherein the data is selected from the group consisting of: audio, mobile telephone, packet data, video, real time duplex data and Internet data.

30. Apparatus for transmitting data comprising a processor arranged to:
a) separate the data into a plurality of data elements;
b) match the position of each data element according to its position in the data with a transmission means;
c) transmit each data element on its matched transmission means;
d) generate parity data from groups of data elements such that any one or more of the data elements within a group may be recreated from the remaining data elements within the group and the parity data for that group;
e) generate further parity data from further groups of data elements formed from the same data elements used in step d) in different combinations; and
f) transmit the parity data and further parity data on separate transmission means.

31. A method of receiving data comprising the steps of:
a) receiving data elements forming original data and parity data from separate transmission means;
b) recreating any missing data elements from the received data elements and parity data to form recreated data elements;
c) matching the received and any recreated data elements to its position in the original data based on the transmission means from which it was received or for which it was recreated; and
d) combining the data elements to form the original data according to its matched position.

32. Apparatus for receiving data comprising a processor arranged to:
a) receive data elements forming original data and parity data from separate transmission means;
b) recreate any missing data elements from the received data elements and parity data to form recreated data elements;
c) match the received data and any recreated data elements to its position in the original data based on the transmission means from which it was received or for which it was recreated; and
d) combining the data elements to form the original data according to its matched position.

33. The apparatus of claim 30, wherein the apparatus is a mobile handset.
